(19) United States
(12) Patent Application Publication
(10) Pub. No.: US 2026/0176398 A1
(43) Pub. Date: Jun. 25, 2026

(54) Curable Polymer Compound and Resin Composition Containing Said Compound

(71) Applicant: Nippon Kayaku Kabushiki Kaisha, Tokyo (JP)

(72) Inventors: Yasumasa Akatsuka, Tokyo (JP); Shigeo Hayashimoto, Tokyo (JP)

(21) Appl. No.: 19/129,709

(22) PCT Filed: Mar. 3, 2023
(86) PCT No.: PCT/JP2023/007995

§ 371 Date: May 14, 2025

(30) Foreign Application Priority Data
Nov. 15, 2022 (JP) 2022-182197

(51) Int. Cl. C08F 220/56; C08F 220/06; C08F 220/18; C08F 220/32

(52) U.S. Cl. CPC C08F 220/56; C08F 220/06; C08F 220/1804; C08F 220/325

(57) ABSTRACT

A polymer compound is expressed by formula (1). The polymer compound is flexible enough to be made into a film, has high adhesiveness to low-roughness copper foil, and has a low dielectric constant and dielectric loss tangent. In the formula (1), R1 each independently represents a hydrogen atom or an alkyl group, and 50 mol % or more of a total of the R₁ are the alkyl group. R₂ and R₃ each independently represent a hydrogen atom or a methyl group. The characters m and n are the averages of the number of repeating units and each independently represent a real number within a range of 1-2,000.

### CROSS-REFERENCE TO RELATED APPLICATIONS

This application is the United States national phase of International Patent Application No. PCT/JP2023/007995 filed Mar. 3, 2023, and claims priority to Japanese Patent Application No. 2022-182197 filed Nov. 15, 2022, the disclosures of which are hereby incorporated by reference in their entireties.

### BACKGROUND OF THE INVENTION

### Field of the Invention

The present invention relates to a polymer compound the solution of which can be easily made into a film by casting it on a base material and is thermally curable or photocurable by using with the radical initiator and the cured product of the solution is excellent in dielectric property, adhesiveness and heat resistance and a resin composition containing said compound.

### Description of Related Art

A phenoxy resin is a polymer compound having a very large molecular weight and obtained by polymerizing a bifunctional epoxy resin and a bifunctional phenolic compound. Because a general epoxy resin composition and a radically polymerizable composition can be made into a film by adding the phenoxy resin, the phenoxy resin is used as an important component of the film adhesive in a wide range of fields. Especially in the electric/electronic field, the phenoxy resin is used for an interlayer insulation layer, a copper foil with resin and the like of the printed wiring board.

The cured product of the resin composition including the phenoxy resin, which can be made into a film, is excellent in adhesiveness, but low heat resistance and moreover has a high dielectric constant and a high dielectric loss tangent (the dielectric constant is about 3.5 and the dielectric loss tangent is about 0.03 at a frequency of 1 GHz), thus there is fact that the resin composition may not be applied to the electronic equipment the response speed of which to a signal is increased recently. As a resin excellent in dielectric properties, the fluorine-containing polymer compounds such as polytetrafluoroethane (PTFE) (Patent Document 1) and the liquid crystal polymer (Patent Document 2) are generally known, but these resins have very low compatibility with the other resins and unsatisfactory adhesiveness. In Patent Document 3, the polymer compound obtained by the esterification reaction between the aliphatic hydroxy group of the random copolymer of a monomer equal to or less than 70 wt % having one ethylenically unsaturate group and a (meth)acryrate equal to or more than 30 wt % having one or more aliphatic hydroxy groups with a monomer having one or more ethylenically unsaturate groups and one carboxy group is disclosed. But the present inventors conducted the supplementary examination and found that the cured product of the polymer compound obtained according to the constitutional formula in Patent Document 3 had a dielectric loss tangent of about 0.005 at 10 GHz and did not satisfy the low dielectric property required for of the recent high-frequency circuit board sufficiently.

### CITATION LIST

### Patent Document

Patent Document 1: JP 2005-001274 A
Patent Document 2: JP 2014-060449 A
Patent Document 3: JP H10-017812 A

### SUMMARY OF THE INVENTION

### Technical Problem

One of the purposes of the present invention is to provide a polymer compound being flexible enough to be made into a film, having high adhesiveness to low-roughness copper foil, having a low dielectric constant and dielectric loss tangent, and having high heat resistance.

### Solution to Problem

By the earnest research, the present inventors found to solve the problems by using a resin composition containing a polymer compound having a specific structure so as to finish the present invention.

That is, the present invention relates to:
[1] A polymer compound represented by following formula (1):

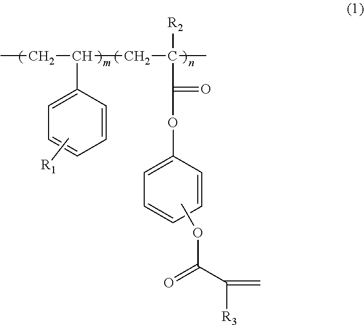

wherein in the formula (1), R₁ each independently represents a hydrogen atom or an alkyl group and 50 mol % or more of R₁ are the alkyl groups, R₂ and R₃ each independently represent a hydrogen atom or a methyl group, and m and n are averages of the number of repeating units and each independently represent real numbers within a range of 1 to 2,000.
[2] A resin composition containing the polymer compound according to item
[1] and a radical polymerization initiator.
[3] The resin composition according to item [2], further containing a compound having a radically reactive group.
[4] A film adhesive of the resin composition according to item [2] or [3].
[5] A cured product of the resin composition according to item [2] or [3].

### Effect of the Invention

One of the resin compositions containing the polymer compound of the present invention and the radical initiator can be made into the cured product by applying thermal or photo energy, and said cured product is excellent in dielectric property, adhesiveness and heat resistance.

### DESCRIPTION OF THE INVENTION

Embodiments of the present invention are described below.

The polymer compound described above has the following formula (1):

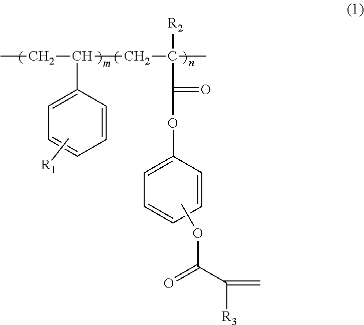

wherein in the formula (1), R₁ each independently represents a hydrogen atom or an alkyl group and 50 mol % or more of R₁ are the alkyl groups, R₂ and R₃ each independently represent a hydrogen atom or a methyl group, and m and n are averages of the number of repeating units and each independently represent real numbers within a range of 1 to 2,000.

In the formula (1), R₁ represents a hydrogen atom or an alkyl group. The hydrogen atom and the alkyl group may exist together. When the hydrogen atom and the alkyl group exist together, 50 mol % or more of R₁ are alkyl groups. More preferably, 60 mol % or more of R₁, further preferably, 70 mol % or more of R₁ are alkyl groups. R₁ is decided by the selection of the raw materials containing the parts corresponding to R₁. When two or more different kinds of the raw materials containing the parts corresponding to R₁ are used, the polymer compound of the formula (1) has two or more different kinds of substituents as R₁. Thus, the description that “50 mol % or more of R₁ are alkyl groups” means that 50 mol % or more of R₁ in the polymer compound of the formula (1) are alkyl groups. Note that the alkyl group that R₁ may be is not particularly limited, but is for example, the linear or brunched alkyl groups having a carbon number of 1 to 30.

R₂ and R₃ each independently represent a hydrogen atom or a methyl group. The existence ratio of the hydrogen atom to the methyl group is not particularly limited.

The m and the n represent the real number within the range of 1 to 2000. When the m and the n are within the range, the desirable number average molecular weight of the polymer compound of the formula (1) is obtained.

The polymer compound represented by the formula (1) is the dehydrochlorinated condensate obtained by the reaction of hydroxy group of the random copolymer of hydroxyphenyl (meth)acrylates and styrenes with chloride group of (meth)acrylic acid chloride or the dehydrated condensate obtained by the reaction of hydroxy group of the random copolymer aforementioned with (meth)acrylic acid.

The random copolymer which is the intermediate raw material in the production of the polymer compound of the formula (1) is described. Examples of hydroxyphenyl (meth)acrylate which is the raw material of the random copolymer include 4-hydroxyphenylmethacrylate, 2-hydroxyphenylmethacrylate, 3-hydroxyphenylmethacrylate, 4-hydroxyphenylacrylate, 2-hydroxyphenylacrylate and 3-hydroxyphenylacrylate. 4-hydroxyphenylmethacrylate is preferable.

Note that in this specification, the word “(meth)acrylate” means both of acrylate and methacrylate.

Styrenes which are the raw materials of the random copolymer encompass alkyl styrene and styrene. Examples of alkyl styrene are preferably alkyl styrene the alkyl group part of which is alkyl group having a carbon number of 1 to 30, include p-methylstyrene, m-methylstyrene, o-methylstyrene and p-t-butylstyrene. These may be used alone or in the mixture thereof. These alkyl styrenes may be also used in the mixture of them and styrene without having alkyl group. When styrene without having alkyl group is used together, 50 mol % or more of the total number of moles of styrenes are alkyl styrene.

The formula (2) described below is the structural formula of the random copolymer of hydroxyphenyl (meth)acrylate and alkyl styrene (and styrene). In formula (2), R₁, R₂, m and n are each the same as R₁, R₂, m and n in formula (1). Namely, the polymer compound represented by formula (1) (the polymer compound having the structure represented by formula (1)) of the present invention is a polymer compound obtained from the intermediate raw material which is the random copolymer represented by following formula (2).

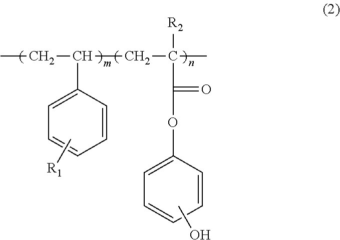

The method of the copolymerization of hydroxyphenyl (meth)acrylate with styrenes (alkyl styrene and styrene) is not particularly limited as long as the method is known conventionally. Examples include bulk polymerization, solution polymerization, emulsion polymerization and suspension polymerization.

Examples of the solvent usable for solution polymerization include toluene, xylene, methylethylketone, methylisobutylketone, cyclopentanone, cyclohexanone, anisole, propyleneglycolmonomethyletheracetate, N-methylpyrrolidone, N, N-dimethylformamide and γ-butyrolactone. Water and surface-active agent are generally used for emulsion polymerization and suspension polymerization. The copolymerization is carried out in the states that the raw material component is emulsified or suspended in water.

The copolymerization reaction may be any one of the radical polymerization, the cation polymerization and the anion polymerization. When the copolymerization reaction is the radical polymerization, the radical polymerization initiator is preferably used. Examples of the radical polymerization initiator include 2,2′-azobisisobutyronitrile, 2,2′-azobis(2-methylbutyronitrile), 2,2′-azobis(2,4-dimethylvaleronitrile), 1,1′-azobis(cyclohexane-1-carbonitrile), 2,2′-azobis [2-(2-imidazoline-2-yl) propane]dihydrochloride, hydrogen peroxide, di-t-butylperoxide, dilauroylperoxide, dicumylperoxide and benzoylperoxide.

The blending amount of the radical polymerization initiator is generally 0.001 to 5 parts by mass based on 100 parts by mass of the total amount of the raw material components of the random copolymer. The polymerization temperature is generally 50 to 250° C., preferably 60 to 200° C. The polymerization time is generally 0.5 to 30 hours, preferably 1 to 20 hours. The radical polymerization is preferably carried out under nitrogen atmosphere to prevent oxygen in the air from inhibiting the polymerization. The living radical polymerization in which the polymerization initiator is used together with the free radical such as TEMPO reagent or with RAFT reagent can be conducted.

Examples of the cation polymerization initiator include inorganic acids such as sulfuric acid and hydrochloric acid, organic acids such as CF₃COOH and CCl₃COOH and super-strong acids such as CF₃SO₃H and HClO₄. Examples of the anion polymerization initiator include butyl lithium, Na-naphthalene complex, alkali metal, alkyl lithium compound, sodium amide, Grignard reagent and lithium alkoxide.

However, because there is concern that the ionic initiator used for the cation polymerization and the anion polymerization remains in the random copolymer after polymerization reaction to affect dielectric property and insulation adversely, the random copolymer which is the intermediate raw material of the polymer compound of the present invention is preferably synthesized by radical polymerization.

The blending amount of the cation polymerization initiator or the anion polymerization initiator is generally 0.01 to 5 parts by mass based on 100 parts by mass of the total amount of the raw material components of the random copolymer. The polymerization temperature is generally 40 to 150° C., preferably 50 to 120° C. The polymerization time is generally 0.5 to 20 hours, preferably 1 to 15 hours.

The number-average molecular weight of the random copolymer which is the intermediate raw material of the polymer compound represented by formula (1) is generally 3,000 to 300,000, preferably 5,000 to 200,000.

The amount of the initiator is preferably adjusted to the proper amount when synthesizing the random copolymer to obtain the copolymer having a number-average molecular weight within the range described above. The amount of the initiator necessary for obtaining the random copolymer having a number-average molecular weight within the range described above is not specified generally, because m and n depend on the kinds of (meth)acrylate having a phenolic hydroxy group and the amount of (meth)acrylate having a hydroxy group and alkyl styrene (and styrene) used for the copolymerization reaction. However, it is generally known that when the amount of the initiator is reduced, the random copolymer having a large molecular weight is obtained. Therefore, the blending amount of the initiator should be selected within the range of the blending amount described above so as to obtain the random copolymer having the desired molecular weight.

The use rates of hydroxyphenyl (meth)acrylate and alkyl styrene (and styrene) when synthesizing the random copolymer which is the intermediate raw material of the polymer compound represented by formula (1) are not particularly limited, but the amount (mass) of alkyl styrene (and styrene) is generally 4 to 99.7 times that of hydroxyphenyl (meth)acrylate, preferably 4.5 to 99.5 times that of hydroxyphenyl (meth)acrylate. By using hydroxyphenyl (meth)acrylate and alkyl styrene (and styrene) which are the raw material of the random copolymer at the ratio within the range described above, the polymer compound of which the cured product exhibits excellent dielectric properties (low dielectric constant and low dielectric loss tangent) can be obtained.

The polymer compound represented by formula (1) can be obtained by dehydrochlorination reaction of a phenolic hydroxy group of the random copolymer aforementioned (this phenolic hydroxy group corresponds to the phenolic hydroxy group of hydroxyphenyl (meth)acrylate which is the raw material) with a chloride group of (meth)acrylic acid chloride or dehydrated condensation reaction of a phenolic hydroxy group of the random copolymer aforementioned with (meth)acrylic acid.

The use rates of the random copolymer and (meth)acrylic acid chloride or (meth)acrylic acid when synthesizing the polymer compound represented by formula (1) are not particularly limited. However, because when the rates of (meth)acrylic acid chloride or (meth)acrylic acid is excessive or short compared to the phenolic hydroxy group of the random copolymer, (meth)acrylic acid chloride or (meth)acrylic acid which remains unreacted or phenolic hydroxy group which remains unreacted with (meth)acrylic acid chloride or (meth)acrylic acid in the polymer compound represented by formula (1) may affect various characteristics of the cured product adversely, (meth)acrylic acid chloride or (meth)acrylic acid equivalent to phenolic hydroxy group of the random copolymer is preferably used.

The reaction of the random copolymer with (meth)acrylic acid chloride may be carried out by adding(meth)acrylic acid chloride to the organic solvent solution of the random copolymer under stirring. The organic solvent used in the reaction is not particularly limited as long as the random copolymer and (meth)acrylic acid chloride can be solved in the solvent. When the random copolymer which is the intermediate raw material is synthesized in the solvent, the random copolymer solution after polymerization reaction can be used as it is. The concentration of the random copolymer solution subjected to the reaction with (meth)acrylic acid chloride is generally 10 to 90% by mass, preferably 20 to 80% by mass. The reaction temperature is generally 30 to 120° C., preferably 40 to 110° C. The reaction time is generally 0.5 to 4 hours, preferably 1 to 3 hours.

Because the reaction of the random copolymer with (meth)acrylic acid chloride is dehydrochlorination reaction, a tertiary amine such as triethylamine or pyridine is preferably added to the reaction solution in advance to trap hydrochloric acid generated and accelerate the reaction further. The amount of the tertiary amine is preferably from 1 to 4 times molar that of (meth)acrylic acid chloride, more preferably from 1 to 3 times molar that of (meth)acrylic acid chloride. Hydrochloric acid generated during the reaction can be removed by filtrating after the reaction because of deposition as an amine hydrochloride. Excessive tertiary amine can be distilled off from the system under heating and reduced pressure after filtration.

Examples of the reaction of the random copolymer with (meth)acrylic acid include conventionally known esterification reaction, for example, the method in which the random copolymer and (meth)acrylic acid are heated and stirred under the presence of the catalyst. Because the reaction of the random copolymer with (meth)acrylic acid is the dehydration reaction, the reaction is preferably carried out while water is removed from the reaction system by azeotropic distillation. Therefore, the reaction is preferably carried out using the solvents which are not mixed with water completely such as toluene, xylene, ethyl acetate, butyl acetate and methylisobutylketone. The amount of the solvent is preferably decided so that the concentration of the raw material of the polymer compound represented by formula (1) can be 20 to 80% by mass.

Examples of the catalyst used for esterification reaction include acid catalyst such as sulfuric acid, methanesulfonic acid and p-toluenesulfonic acid. The amount used is preferably 0.1 to 5% by mass based on the total mass of the raw material of the polymer compound represented by formula (1), solvent and the like used for the reaction. The reaction temperature is generally 50 to 150° C., preferably 60 to 140° C. The reaction time is generally 0.5 to 4 hours, preferably 1 to 3 hours.

To prevent polymerization reaction of (meth)acryloyl groups with each other in the polymer compound represented by formula (1) during storage of the polymer compound of formula (1), a small amount of polymerization inhibitor is preferably added to the polymer compound of formula (1) solution, after the synthetic reaction is finished. Examples of the polymerization inhibitor include hydroquinone, paramethoxyphenol, methylhydroquinone, di-t-butylhydroxytoluene, t-butylhydroquinone, 2-t-butyl-1,4-benzoquinone, 1,4-benzoquinone, 1,1-diphenyl-2-picrylhydrazyl free radical, 6-t-butyl-2,4-xylenol, 4-t-butylpyrocatechol, 2,6-di-t-butylphenol, 2,6-di-t-butyl-p-cresol and phenothiazine.

The range of the number average molecular weight of the polymer compound represented by formula (1) and obtained in above is preferably 11,000 to 300,000, more preferably 15,000 to 200,000. When the molecular weight is smaller than the range aforementioned, the adhesiveness to the low roughness copper foil may become low. When the molecular weight is larger than the range aforementioned, the viscosity may become high and the coating and the like may become difficult.

Note that the molecular weight in the present specification means the value calculated in terms of polystyrene based on the GPC measurement results.

In the specification, the resin composition contains the polymer compound of formula (1) and the radical initiator. Both the thermal radical initiator and the photo radical initiator can be used as the radical initiator.

Examples of the preferable thermal radical initiator include a peroxide such as benzoylperoxide, cumenehydroperoxide, 2,5-dimethylhexane-2,5-dihydroperoxide, 2,5-dimethyl-2,5-di(t-butylperoxy) hexyne-3, di-t-butylperoxide, t-butylcumylperoxide, α,α-bis(t-butylperoxy-m-isopropyl)benzene, 2,5-dimethyl-2,5-di(t-butylperoxy) hexane, dicumylperoxide, di-t-butylperoxyisophthalate, t-butylperoxybenzoate, 2,2-bis(t-butylperoxy) butane, 2,2-bis(t-butylperoxy) octane, 2,5-dimethyl-2,5-di(benzoylperoxy) hexane, di(trimethylsilyl) peroxide and trimethylsilyltriphenylsilylperoxide.

Examples of the preferable photo radical initiator include benzoin and alkyl ether thereof such as benzoin, benzoin methyl ether and benzoin ethyl ether; acetophenone such as acetophenone, 2,2-dimethoxy-2-phenylacetophenone and 1,1-dichloroacetophenone; anthraquinone such as 2-methylanthraquinone, 2-amylanthraquinone, 2-t-butylanthraquinone and 1-chloroanthraquinone; thioxanthone such as 2,4-dimethylthioxanthone, 2,4-diisopropylthioxanthone and 2-chlorothioxanthone; ketal such as acetophenonedimethylketal and benzyldimethylketal; benzophenone such as benzophenone; 2-methyl-1-[4-(methylthio)phenyl]-2-morpholino-propane-1-one or 2-benzyl-2-dimethylamino-1-(4-morpholinophenyl)-butanone-1; acyl phosphineoxide and xanthone.

The content of the radical initiator in the resin composition is generally 0.1 to 10 parts by mass, preferably 0.1 to 8 parts by mass based on 100 parts by mass of total of the resin components such as the polymer compound represented by formula (1) and the radical-reactive monomer which is an optional component described below.

The compound having a radically reactive group may be used together with the resin composition. The compound having the radically reactive group and usable with the resin composition of the present invention together is either of the radical-reactive monomer having a number average molecular weight of about less than 1,000 and the radical-reactive polymer having a number average molecular weight of about 1,000 or more. Both of them can be used together.

Examples of the radical-reactive monomer having the radically reactive group include acenaphthylene, N-phenylmaleimide, N-vinyl-2-pyrrolidone, ethyleneglycoldimethacrylate, diethyleneglycoldimethacrylate, triethyleneglycoldimethacrylate, 1,4-butanedioldimethacrylate, neopentylglycoldimethacrylate, 1,6-hexanedioldimethacrylate, 1,9-nonanedioldimethacrylate, glycerindimethacrylate, 2-hydroxy-3-acryloyloxypropylmethacrylate, ethyleneoxide adduct methacrylate of bisphenol A, trimethylolpropanetrimethacrylate, tricyclodecanedimethanoldimethacrylate, glycerindimethacrylate, trimethylolpropanetrimethacrylate, ethoxylated isocyanuric acid triacrylate, ¿-caprolactone-modified tris-(2-acryloxyethyl) isocyanurate, pentaerythritoltriacrylate, ditrimethylolpropanetetraacrylate, ethoxylated pentaerythritoltetraacrylate, pentaerythritoltetraacrylate, dipentaerythritolpolyacrylate, dipentaerythritolhexaacrylate, triallylisocyanurate, triallylcyanurate, divinylbenzene, divinyl isophthalate, N-phenyl-maleimide, N-phenyl-methylmaleimide, N-phenyl-chloromaleimide, N-p-chlorophenyl-maleimide, N-p-methoxyphenyl-maleimide, N-p-methylphenyl-maleimide, N-p-nitrophenyl-maleimide, N-p-phenoxyphenyl-maleimide, N-p-phenylaminophenyl-maleimide, N-p-phenoxycarbonylphenyl-maleimide, 1-maleimide-4-acetoxysuccinimide-benzene, 4-maleimide-4′-acetoxysuccinimide-diphenylmethane, 4-maleimide-4′-acetoxysuccinimide-diphenylether, 4-maleimide-4′-acetoamide-diphenylether, 2-maleimide-6-acetoamide-pyridine, 4-maleimide-4′-acetoamide-diphenylmethane, N-p-phenylcarbonylphenyl-maleimide, N-ethylmaleimide, N-2,6-xylylmaleimide, N-cyclohexylmaleimide, N-2,3-xylylmaleimide, xylylmaleimide, 2,6-xylenemaleimide and 4,4′-bismaleimidediphenylmethane. The compound having a maleimide group as a functional group (maleimide compound) is preferable.

These radical-reactive monomers may be used alone or in the mixture of two or more.

By using the radical-reactive monomer together reactivity of the resin composition, the heat resistance of the cured product and the like can be improved.

The content of the radical-reactive monomer in the resin composition is generally 50% by mass or less relative to the polymer compound of formula (1), preferably 2 to 40% by mass.

Examples of the radical-reactive polymer having radically reactive group include the modified polyphenylene ether having the methacryloyl groups at both ends and represented by the following formula (3) (product name SA-9000 manufactured by SABIC Japan LLC), the modified polyphenylene ether having the styryl groups at both ends and represented by the following formula (4) (product name OPE-2St manufactured by MITSUBISHI GAS CHEMICAL COMPANY, INC.), the multifunctional styrene resin represented by the following formula (5) (product name STR manufactured by Nippon Kayaku Co., Ltd.) and the styrene-butadiene copolymer. Note that n and p in the formulas (3) to (5) are averages of the number of repeating units, generally 2 to 100, preferably 4 to 80.

The number average molecular weight of the radical-reactive polymer represented by any one of the formulas (3) to (5) is preferably 1,000 to 3,000. Using the radical-reactive monomer having the number average molecular weight of 500 or more and less than 1,000 and represented by any one of the formulas (3) to (5) together with the resin composition of the present invention is also preferable embodiment.

By using the radical-reactive polymer together reactivity of the resin composition, heat resistance of the cured product and the like can be improved.

The content of the radical-reactive polymer in the resin composition is generally 80% by mass or less relative to the polymer compound represented by formula (1), preferably 5 to 70% by mass.

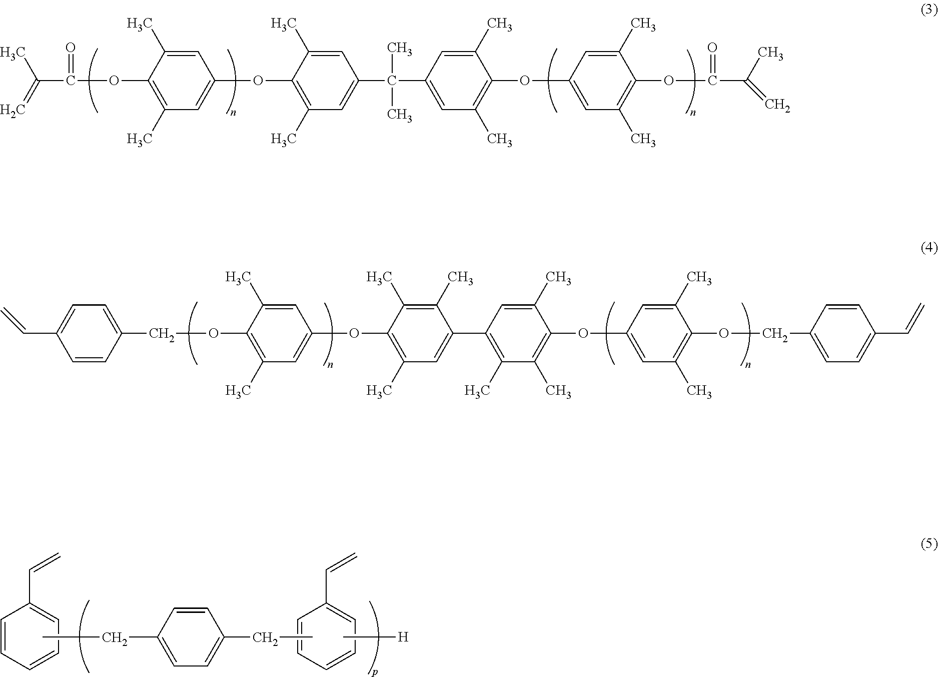

The organic solvent may be contained in the resin composition. Examples of the organic solvent include aromatic solvent such as toluene and xylene; ether solvent such as diethyleneglycoldimethylether, diethyleneglycoldiethylether, propyleneglycol, propyleneglycolmonomethylether, propyleneglycolmonomethylethermonoacetate and propyleneglycolmonobutylether; ketone solvent such as methylethylketone, methylisobutylketone, cyclopentanone and cyclohexanone; lactone such as γ-butyrolactone and γ-valerolactone; amide solvent such as N-methylpyrrolidone (NMP), N, N-dimethylformamide (DMF), N, N-dimethylacetamide and N, N-dimethylimidazolidinone; sulfone such as tetramethylenesulfone. The content of the organic solvent in the resin composition is generally not more than 90% by mass in the resin composition, preferably 30 to 80% by mass.

The polymerization inhibitor may be used together in the resin composition to improve storage stability. The polymerization inhibitor usable together is not particularly limited as long as it is generally well-known. Examples include quinone such as hydroquinone, methylhydroquinone, p-benzoquinone, chloranil and trimethylquinone, aromatic diol and di-t-butylhydroxytoluene.

The resin composition can be used by being blended with the filler and the additive as much as the original performance of the resin composition is not impaired for the purpose of giving the desired performance according to the application. The filler may be fibrous or powdery. Examples of the filler include silica, carbon black, alumina, talc, mica, glass beads and hollow glass sphere.

The flame-resistant compound, the additive and the like can be added to the resin composition. These are not particularly limited as long as these are used generally. Examples of the flame-resistant compound include bromine compounds such as 4,4-dibromobiphenyl, phosphate ester, melamine phosphate, phosphorus-containing epoxy resin, nitrogen compound such as melamine and benzoguanamine, oxazine ring-containing compound and silicon compound. Examples of the additive include ultraviolet absorber, antioxidant, photopolymerization initiator, fluorescent brightening agent, photosensitizer, dyes, pigment, thickener, lubricant, defoaming agent, dispersant, leveling agent, brightener. The additive can be used in combination according to circumstance if so desired.

The resin composition can be used by applying on various base materials or impregnating. For example, when the thermal radical initiator is used, the resin composition can be used as the interlayer insulation layer of the multilayer printed board by applying on the PET film, as the cover lay by applying on the polyimide film and as the copper foil with resin by drying after applying on the copper foil. The resin composition can be used as the printed wiring board and the CFRP prepreg by impregnating glass cloth or glass paper, carbon fiber, a variety of nonwoven fabric and the like with the resin composition. In addition, the resin composition can be used as a variety of resist by using the photo radical initiator.

The interlayer insulation layer and the cover lay, the copper foil with resin, the prepreg and the like can be made into the cured product by applying heat and pressure with the hot press machine and the like to form.

### EXAMPLES

The present invention will be explained in more detail with Examples and Comparative Examples hereinafter, but is not limit to these Examples. In Examples and Comparative Examples, the “part” and “%” mean “part by mass” and “% by mass” respectively unless specified otherwise.

### Example 1 (Synthesis of Polymer Compound 1)

### (Step 1) Synthesis of Random Copolymer Represented by Following Formula (6) (Random Copolymer 1)

Into the flask provided with a thermometer, a cooling pipe, an nitrogen introducing pipe and a stirring device, 98.4 parts of 4-methylstyrene, 1.6 parts of 4-hydroxyphenylmethacrylate, 0.05 parts of azobisisobutyronitrile and 50 parts of toluene were added and reacted under nitrogen atmosphere with raising temperature to 120° C. for 6 hours to obtain the toluene solution of the random copolymer 1 represented by following formula (6). A part of the solution was analyzed by the gas chromatography and unreacted 4-hydroxyphenylmethacrylate did not remain. A part of the toluene solution described above was heated under reduced pressure to remove the solvent and the unreacted 4-methylstyrene. The obtained mass amount of the random copolymer 1 calculated by regarding the dry mass as a solid component amount was 60.5 parts. Considering that the unreacted 4-methylstyrene was 37.9 parts, the random copolymer 1 obtained was the copolymer of 58.9 parts of 4-methylstyrene and 1.6 parts of 4-hydroxyphenylmethacrylate. The number average molecular weight of the sample subjected to the measurement of the dry mass aforementioned was 39,000 and the weight average molecular weight was 161,000. The n and min formula (6) calculated from the copolymerization ratio of 4-methylstyrene and 4-hydroxyphenylmethacrylate and the number average molecular weight were 322 and 6, respectively.

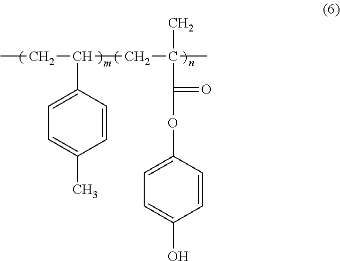

### (Step 2) Synthesis of Polymer Compound Represented by Following Formula (7) (Polymer Compound 1)

After distilling off the unreacted 4-methylstyrene and toluene under reduced pressure and heating from the toluene solution of the random copolymer 1 obtained in Step 1, 150 parts of toluene were added to obtain the toluene solution of the random copolymer 1.1.18 parts of triethylamine and 0.94 parts of methacrylic acid chloride were added to the solution and reacted at 70° C. under stirring for 1 hour. By dropping the reaction liquid in a large excess of methanol, the polymer compound was precipitated and was subjected to filtration. By drying under reduced pressure, 55.2 parts of the polymer compound represented by following formula (7) (The polymer compound 1) were obtained. The number average molecular weight of the polymer compound 1 obtained was 41,000 and the weight average molecular weight was 172,000.

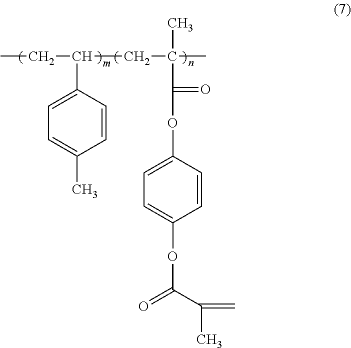

### Comparative Example 1 (Synthesis of Polymer Compound 2)

### (Step 3) Synthesis of Random Copolymer Represented by Following Formula (8) (Random Copolymer 2)

In the same way as Step 1 except for replacing 4-methylstyrene with styrene the number of moles of which is the same as that of 4-methylstyrene, the toluene solution of the copolymer 2 represented by following formula (8) was obtained. A part of the solution was analyzed by the gas chromatography and unreacted 4-hydroxyphenylmethacrylate did not remain. A part of the toluene solution described above was heated under reduced pressure to remove the solvent and the unreacted styrene. The obtained mass amount of the random copolymer 2 calculated by regarding the dry mass as a solid component amount was 59.5 parts. Considering that the unreacted styrene was 40.5 parts, the random copolymer 2 obtained was the copolymer of 57.9 parts of styrene and 1.6 parts of 4-hydroxyphenylmethacrylate. The number average molecular weight of the sample subjected to the measurement of the dry mass aforementioned was 35,000 and the weight average molecular weight was 155,000. The n and m in formula (8) calculated from the copolymerization ratio of styrene and 4-hydroxyphenylmethacrylate and the number average molecular weight were 328 and 5, respectively.

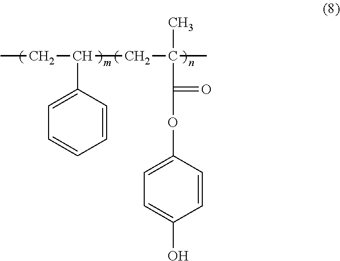

### (Step 4) Synthesis of the Polymer Compound Represented by Following Formula (9) for Comparison (Polymer Compound 2)

In the same way as Step 2 except for replacing the toluene solution of the random copolymer 1 obtained in Step 1 with the toluene solution of the random copolymer 2 obtained in Step 3, 53.2 parts of the polymer compound represented by the following formula (9) for comparison (polymer compound 2) was obtained. The number average molecular weight of the polymer compound 2 obtained was 39,000 and the weight average molecular weight was 162,000.

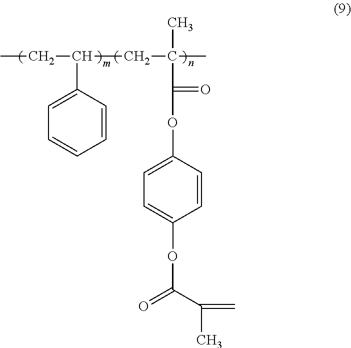

### Example 2 (Preparation of Resin Composition)

The resin composition 1 was obtained by adding 0.05 parts of dicumylperoxide as a radical initiator to 10 parts of the 25% solution obtained by solving 2.5 parts of the polymer compound 1 of the present invention obtained in Example 1 in toluene and mixing homogeneously.

### Example 3 (Preparation of Resin Composition)

The resin composition 2 was obtained by adding 0.05 parts of dicumylperoxide as a radical initiator to 10 parts of the 25% solution obtained by solving 2.375 parts of the polymer compound 1 obtained in Example 1 and 0.125 parts of bis(3-ethyl-5-methyl-4-maleimidephenyl) methane in toluene and mixing homogeneously.

### Comparative Example 2 (Preparation of Resin Composition for Comparison)

In the same way as Example 2 except for replacing the polymer compound 1 obtained in Example 1 with the polymer compound 2 obtained in Comparative example 1, the resin composition 3 for comparison was obtained.

### Evaluation of Dielectric Properties and Heat Resistance of Cured Product of Resin Composition

The resin compositions 1, 2 and 3 obtained in Examples 2, 3 and Comparative Example 2 were applied on the mirror surfaces of the copper foils having a thickness of 18 μm for the applied film thickness to be 280 μm by using the applicator. The copper foil having film adhesive of each resin composition was obtained by heating the resin composition at 90° C. for 10 minutes to dry the solvent. The film adhesives on the copper foils obtained above were cured by heating at 180° C. for 1 hour in the vacuum oven. Then, the cured products of the film adhesives with a thickness of 70 μm which can be handled as a film were obtained by removing the copper foils from the film adhesives stuck on the copper foils through soaking in the etchant. The values of dielectric constant and dielectric loss tangent of the cured products obtained the above at 10 GHz were measured by using Network analyzer 8719ET (manufactured by Agilent Technologies Japan, Ltd.) by the cavity resonance method. The results were shown in Table 1. The glass transition temperature and the linear expansion coefficient (a1, a2) of the same samples were measured by using TMA (Thermomechanical Analyzer). The results were shown in Table 1.

### Evaluation of Adhesive Strength of Cured Product of Resin Composition

The resin compositions 1, 2 and 3 obtained in Examples 2, 3 and Comparative Example 2 were applied on the matted surface of the high frequency low roughness copper foil with a thickness of 12 μm (CF-T4X-SV: manufactured by FUKUDA METAL FOIL and POWDER Co., Ltd.) by using the applicator for the applied film thickness to be 50 μm. The copper foil having film adhesive of each resin composition was obtained by heating the resin compositions at 90° C. for 10 minutes to dry the solvent. Onto the adhesive application surfaces of the copper foils with the resins obtained above, the matted surface of the same copper foil as described above was put and the resin compositions were cured by heating with the pressure of 3 MPa in vacuum for 1 hour. Then, the values of the 90° peeling strength between the copper foils (adhesive strength) were measured by using Autograph AGX-50 (manufactured by Shimazu Corporation). The results were shown in Table 1.

### Table 1 Evaluation Results of Cured Products of Resin Compositions

TABLE 1
Evaluation results of cured products of resin compositions

| | Resin | Resin | Resin |
|---|---|---|---|
| | composition | composition | composition |
| Resin composition | 1 | 2 | 3 |
| Dielectric constant [10 GHz] | 2.50 | 2.42 | 2.45 |
| Dielectric loss tangent | 0.00070 | 0.00067 | 0.00110 |
| [10 GHz] | | | |
| Glass transition | 110 | 125 | 108 |
| temperature[° C.] | | | |
| α 1 [ppm/° C.] | 72 | 65 | 75 |
| α 2 [ppm/° C.] | 125 | 115 | 1260 |
| Adhesive strength [N/mm] | 0.60 | 0.55 | 0.60 |

As seen in the above, when the resin composition containing the polymer compound 1 of formula (1) with the radical initiator is cured, the cured products of the resin compositions were formed into the flexible films and furthermore exhibited excellent dielectric properties, heat resistance and adhesiveness.

1. A polymer compound represented by following formula (1): 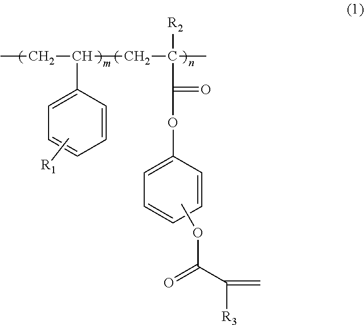
wherein in the formula (1), R₁ each independently represents a hydrogen atom or an alkyl group and 50 mol % or more of a total of the R₁ are the alkyl group, R₂ and R₃ each independently represent a hydrogen atom or a methyl group, and m and n are averages of the number of repeating units and each independently represents a real number within a range of 1 to 2,000.

2. A resin composition containing the polymer compound according to claim 1 and a radical polymerization initiator.

3. The resin composition according to claim 2, further containing a compound having a radically reactive group.

4. A film adhesive of the resin composition according to claim 2.

5. A cured product of the resin composition according to claim 2.
